(19) United States
(12) Patent Application Publication
(10) Pub. No.: US 2017/0336564 A1
(43) Pub. Date: Nov. 23, 2017

(54) ULTRALOW-ENERGY ELECTRO-OPTICAL LOGIC AND NxN SWITCHING BY RESONANT ON-CHIP NANOBEAM WAVEGUIDE NETWORKS

(71) Applicant: UNIVERSITY OF MASSACHUSETTS, Boston, MA (US)

(72) Inventor: Richard Soref, Chestnut Hill, MA (US)

(21) Appl. No.: 15/598,472

(22) Filed: May 18, 2017

Related U.S. Application Data
(60) Provisional application No. 62/338,230, filed on May 18, 2016.

(51) Int. Cl. G02B 6/12; G02B 6/293; G02B 6/122; H04Q 11/00; G02F 1/313

(52) U.S. Cl. CPC G02B 6/12007; H04Q 11/0005; G02F 1/3133; G02B 6/1225; G02B 6/2938; G02B 6/29395

(57) ABSTRACT

An ultralow-energy electro-optical 2×2 cross-bar switch comprises an identical pair of semiconductor nanobeams that are incorporated in the central arms of a waveguided Mach-Zehnder interferometer. Each nanobeam includes a one dimensional “lattice” of holes along the nanobeam axis that defines a resonant cavity whose fundamental mode is the operating wavelength of the switch. A localized, lateral lengthwise extending portion of the semiconductor nanobeam is doped P type, while the other lateral half of the nanobeam wing is doped N type, forming a P-N junction in the body. Application of an electric potential across the P-N junction alters the effective index of refraction of the lengthwise extending portion and controls both the transmission and reflection of an incoming optical signal at the operating wavelength of the switch through the semiconductor nanobeam. Constructive and destructive interference of component signals within the interferometer controls the spatial routing of the incident light.

### CROSS-REFERENCE TO RELATED APPLICATIONS

This application claims priority under 35 U.S.C. §119(e) to U.S. Provisional Patent Application No. 62/338,230, titled “ULTRALOW-ENERGY ELECTRO-OPTICAL LOGIC AND N×N SWITCHING BY RESONANT ON-CHIP NANOBEAM WAVEGUIDE NETWORKS” filed May 18, 2016, which is incorporated by reference herein in its entirety for all purposes.

### BACKGROUND

Modern high speed telecommunications systems often employ optical switches to route data, for example, digital data or voice data through fiber optic communication pathways. The telecommunications industry may benefit from higher performance or lower cost optical switches, including, for example, electro-optical switches. Similarly, as optical computing technologies are being developed, an increased need for electro-optical switches that can link traditional electronic computing system components with optical computing components is developing. For packet switching or bit-by-bit switching, and for minimization of energy consumption in modern large-scale networks, there is a strong need for electro-optical switches that draw 0.5 to 1.0 femptoJoules per bit or less.

### SUMMARY

In accordance with one aspect, there is provided an ultralow-energy electro-optical 1×1 switch. The switch comprises a semiconductor nanobeam including a strip body upon a localized rib platform, and a plurality of air-hole cavities etched in the body, disposed along a length of the semiconductor nanobeam, and spaced from one another at regular intervals, the spacing between the air-hole cavities and their diameters defining a resonant cavity and an operating optical wavelength of the 1×1 switch, a lengthwise extending portion of the semiconductor nanobeam including p-type semiconductor and n-type semiconductor forming a lateral p-n junction in the body, application of an electric potential across the p-n junction altering an index of refraction of the lengthwise extending portion and controlling transmission of an optical lightwave signal at the operating wavelength of the 1×1 switch through the semiconductor nanobeam.

In some embodiments, application of a reverse bias across the p-n junction blocks transmission of the signal through the semiconductor nanobeam and reflects the signal.

The semiconductor may comprise silicon.

In some embodiments, the semiconductor nanobeam is disposed on an oxide substrate.

In some embodiments, the switch is operable to control transmission of the signal utilizing less than 500 attojoules of energy per bit.

In some embodiments, the switch is operable to transmit a signal at only a single wavelength corresponding to the central wavelength of a narrow resonance passband.

In some embodiments, a pair of the 1×1 switches is included in a dual nanobeam 2×2 switch and are arranged within the central connecting-waveguide arms of a waveguided 2×2 Mach-Zehnder interferometer comprising a first optical 3-dB coupler optically coupling first ends of the nanobeams of the pair of 1×1 switches and a second optical 3-dB coupler optically coupling second ends of the nanobeams of the pair of 1×1 switches. The pair of 1×1 switches may each have the same operating wavelenth. An electro-optical logic unit cell may include two of the dual nanobeam switches arranged in parallel. A wavelength selective switch may include a plurality of the dual nanobeam switches. Subsets of the plurality of dual nanobeam switches may have different operating wavelengths.

In some embodiments, a pair of the 1×1 switches is included in a dual nanobeam 2×2 switch. A first 2×2 multi-mode interferometer may optically couple first ends of the nanobeams of the pair of 1×1 switches and a second 2×2 multi-mode interferometer may optically couple second ends of the nanobeams of the pair of 1×1 switches.

### BRIEF DESCRIPTION OF THE DRAWINGS

Various aspects of at least one embodiment are discussed below with reference to the accompanying figures, which are not intended to be drawn to scale. The figures are included to provide illustration and a further understanding of the various aspects and embodiments, and are incorporated in and constitute a part of this specification, but are not intended as a definition of the limits of the invention. In the figures, each identical or nearly identical component that is illustrated in various figures is represented by a like numeral. For purposes of clarity, not every component may be labeled in every figure. In the figures:

FIG. 1 illustrates an embodiment of an electro-optical switch element;

FIG. 2 illustrates a cross section of a p-n junction in a nano-beam of the electro-optical switch element of FIG. 1 in a forward biased state;

FIG. 3 illustrates a cross section of a p-n junction in a nano-beam of the electro-optical switch element of FIG. 1 in a reverse biased state;

FIG. 4 illustrates an embodiment of a 2×2 dual-nano-beam electro-optical switch;

FIG. 5 illustrates another embodiment of a 2×2 dual-nano-beam electro-optical switch;

FIG. 6 illustrates the results of a simulation of transmission and reflectance of different frequencies of light in an example of a 2×2 dual-nano-beam electro-optical switch with different p-n junction biasing;

FIG. 7 illustrates an embodiment of a 4×4 path-independent-loss electro-optical switch;

FIG. 8 illustrates an embodiment of a 3×3 wavelength selective electro-optical switch;

FIG. 9 illustrates a logic unit cell formed from a pair of 2×2 dual-nano-beam electro-optical switches and passive pass-or-block nanobeams; and

FIG. 10 illustrates a 3-wavelength 1×4 wavelength-routing switch formed from wavelength-dedicated trees, each tree made of three 2×2 dual nano beam electro optical switches.

### DETAILED DESCRIPTION

Aspects and embodiments disclosed herein include narrowband electro-optical switches and filters that may function to electrically control the routing of an optical signal and that may be used to multiplex or de-multiplex optical signals.

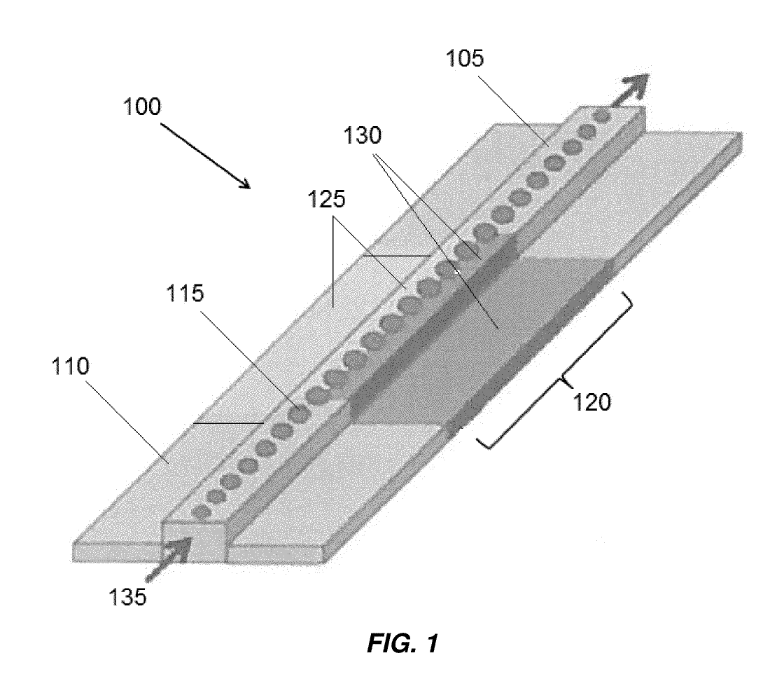

An electro-optical switch element, generally indicated at 100, is illustrated in FIG. 1. The electro-optical switch element 100 includes a nano-beam 105 disposed on a rib-waveguide substrate 110. The nano-beam 105 may comprise or consist of a semiconductor, for example, silicon, and the substrate 110 may be a silicon-on-insulator (SOI) type substrate. The nano-beam 105 includes a plurality of evenly spaced air-holes 115 that comprise a one-dimensional photonic-crystal lattice. The air-holes 115 and their diameters define a resonant cavity in the nano-beam 105 with a resonant wavelength λ corresponding to the center-of-band wavelength of light 135 that will pass through the nano-beam 105. The spacing of the air-holes 115 and the index of refraction of the material of the nano-beam 105 define the particular wavelength of light 135 that will pass through the nano-beam 105. The nano-beam channel waveguide 105 acts as a filter for the broad incident light 130. The electro-optical switch element 100 further includes a localized, lateral p-n junction 120 along at least a portion of its length. The semiconductor material of the nano-beam 105 includes semiconductor material 125 of a first conductivity type, for example, P-type, that extends across a first side-portion of the width of the nano-beam 105 and semiconductor material 130 of a second conductivity type, for example, N-type, that extends across a second opposing-side-portion of the width of the nano-beam 105. In a non-limiting example the P-type first side portion of the nano-beam 105 may have a width of about 285 nm and a doping of about 5×10¹⁷ cm⁻³ and the N-type second side portion of the nano-beam 105 may have a width of about 215 nm and a doping of about 1×10¹⁶ cm⁻³. The nano-beam 105 may have a height of about 220 nm above the surface of the substrate 110. Portions of the semiconductor material not included in the nano-beam but disposed on the substrate 110 may have heights of about 50 nm.

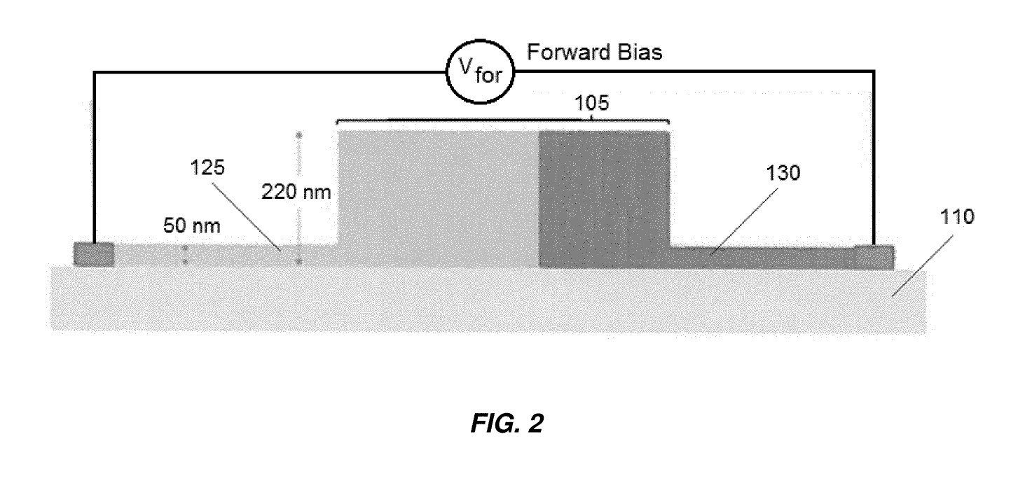

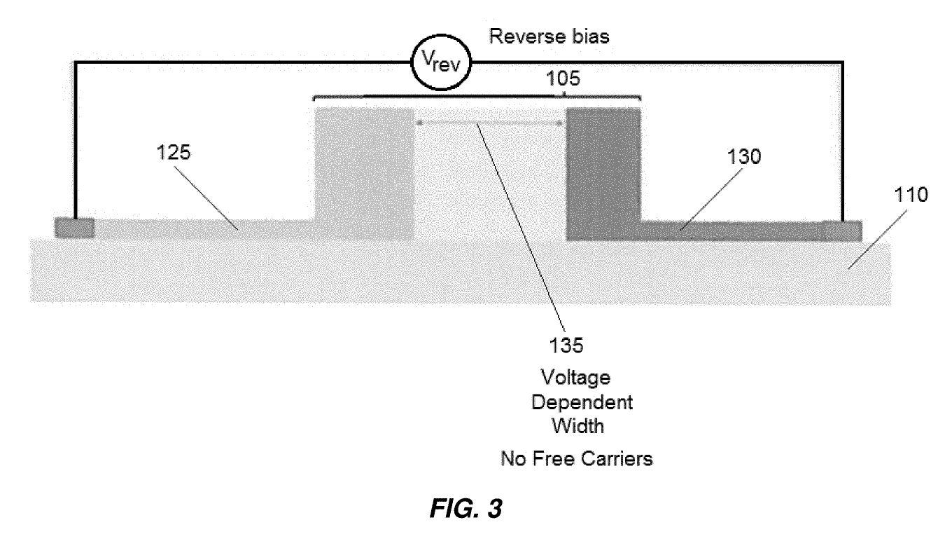

The transmittance of the electro-optical switch element 100 for light of wavelength λ may be controlled by biasing of the p-n junction 120. For example, if the p-n junction 120 is slightly forward biased as illustrated in FIG. 2, or in some embodiments, unbiased, the nano-beam 105 is transmissive to light of wavelength λ. If, as shown in FIG. 3, the p-n junction 120 is reverse biased, a depletion region 135 is formed in the nano-beam 105. The depletion of electrons and holes within region 135 changes the effective index of refraction of the nano-beam 105, shifting the resonant wavelength to a longer wavelength and rendering the nano-beam 105 non-transmissive to light of wavelength λ. Denoting the transition from undepleted to depleted as a “one bit swing,” the device of FIG. 1 consumes only about 500 attojoules per bit, a unique performance in the electro-optical art. Light of wavelength λ introduced into the nano-beam 105 when the p-n junction 120 is reverse biased will be reflected rather than transmitted. The dimensions shown in FIG. 2 are examples only and aspects and embodiments disclosed herein are not limited to these dimensions.

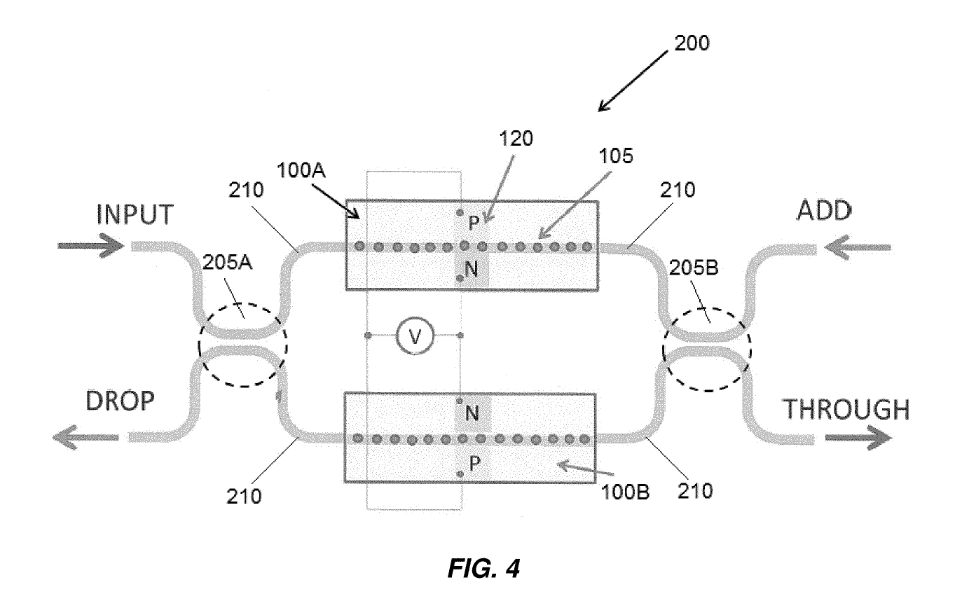

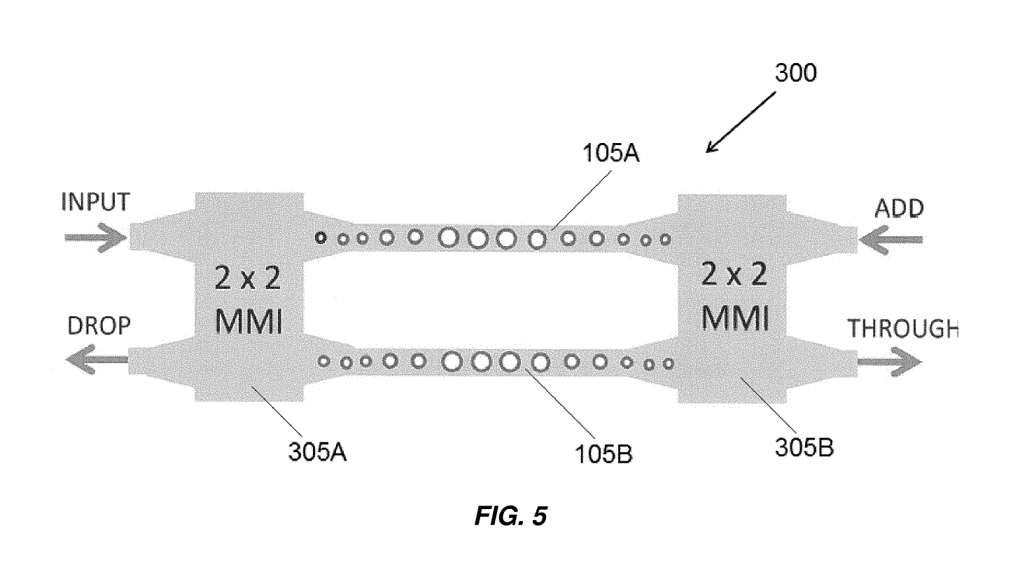

As illustrated in FIG. 4, a pair of electro-optical switch elements 100A, 100B may be combined with a pair of 3-dB optical couplers 205A, 205B to form a 2×2 dual-nano-beam electro-optical switch 200 in the Mach-Zehnder interferometer architecture. The pair of electro-optical switch elements 100A, 100B are connected on either side to waveguides, for example silicon on insulator (SOI) waveguides 210 that conduct light to and from the electro-optical switch elements 100A, 100B. The optical couplers 205A, 205B are formed where portions of the waveguides 210 come into close proximity to one another for evanescent side-coupling. A similar device 300 is illustrated in FIG. 5 in which the waveguides 210 of the 2×2 dual-nano-beam electro-optical switch 200 are combined into 2×2 multi-mode interferometers 305A, 305B on each side of the nano-beams 105A, 105B. Details of the device 300, for example, the p-n junctions in the nano-beams 105A, 105B are not illustrated in FIG.5 for ease of illustration. Each of the two MMIs in FIG. 5 uses ray interference within the rectangular slab waveguide to provide the same functions as the 3-dB couplers in FIG. 4, namely an equal division of optical power at the two outputs, and a 90 degree optical phase shift of output-2 with respect to the phase of output-1.

Each of the two identical nano-beam strips 105A, 105B in the two electro-optical switch rib-waveguide elements 100A, 100B contains identical localized lateral p-n junctions 120 that can be depleted of free carriers when they are swept out by an applied reverse bias. This depletion changes the effective refractive index of the resonant region of the nano-beams 105 and thereby shifts the resonance wavelength of each nano-beam 105 along the wavelength axis by at least one linewidth of the resonance (the width of the resonant passband of the nano-beam 105).

Depletion is chosen because it is the lowest-energy free carrier electro-optical effect known in photonic physics. PIN injection of free carriers is also effective here, but at higher energy.

The four ports of the switch 200 are labeled Input, Through, Add, and Drop because this resonant device can perform the function of an add-drop multiplexer within a wavelength-division multiplexed optical interconnect system. One color of a multicolor input can be dropped when desired. In addition, a color can be added to the optical data stream if desired. But this add-drop function is just one of several switching functions that the device can provide.

The switch has two states, known as the cross and the bar states. These states may also be referred to as State 1 or State 2. State 1 is when the p-n junctions in both nano-beams 105 are not depleted. State 1 is achieved at zero bias across the p-n junctions 120 on both nano-beams 105, or perhaps with a small forward bias across the p-n junctions 120. State 2 is attained when the p-n junctions 120 on both nano-beams 105A, 105B are in the “full reverse bias” condition, where full means that the resonance has been shifted by one linewidth.

Both nano-beams 105A, 105B are biased off and on (depleted or not depleted) in unison.

The operation of the 2×2 dual-nano-beam electro-optical switch 200 utilizes the constructive interference of two waveguided light beams at one port as well as the destructive interference of two such beams at another port. By definition of State 1 and State 2, in State 1 each nano-beam 105A, 105B is in its fully transmissive optical state, whereas in State 2, each nano-beam 105A, 105B is in its fully reflective optical state.

Regarding the directional couplers 205A, 205B of FIG. 4, and the multimode interference couplers in FIG. 5, each of these 3-dB couplers performs the same 50/50 splitting function as follows: a light beam input to the coupler produces a half-power straight-through beam and a half-power split-off light beam that has an added 90-degree phase shift. The phase shift is going to add or subtract to the phase of another light beam.

In State 1, the half-power straight-through beam is transmitted through electro-optical switch element 100A and is further split by coupler 205B, whereas the half-power split-off light beam travels to electro-optical switch element 100B and is further divided by coupler 205B. The component light beams that exit from coupler 205B interfere constructively at the Through port, and destructively at the Add port.

In State 2, both electro-optical switch element 100A, 100B are reflective to light at wavelength λ, and so the incoming two half beams are reflected back into coupler 205A, where they are again divided by that coupler. The reflected light beams interfere constructively at the Drop port, and destructively at the Input port. Thus, depending on the state of the electro-optical switch elements 100A, 100B all the light at wavelength λ introduced through the Input port goes either to the Through or to the Drop port.

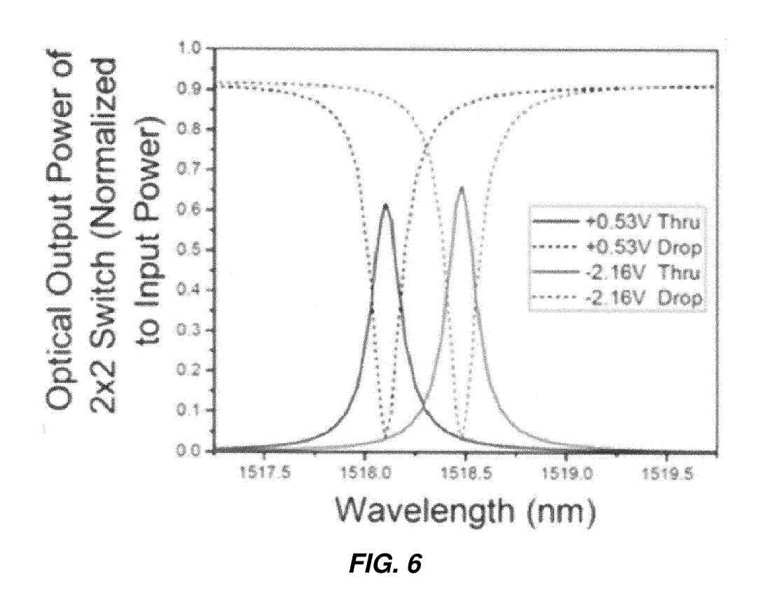

FIG. 6 illustrates the results of a simulation of transmission and reflectance of different frequencies of light (light reaching the Through port being transmitted and light reaching the Drop port being reflected) of an example of a 2×2 dual-nano-beam electro-optical switch with different p-n junction biasing. It should be noted that for this behavior to be observed the entire resonant cavity portions of the nano-beams in the electro-optical switch (a few micrometers in length) would have to include p-n junctions. Having first chosen the State 1 resonance wavelength as the operation wavelength, these results show how a 2×2 dual-nano-beam electro-optical switch as disclosed herein may route that light to different spatial locations upon demand.

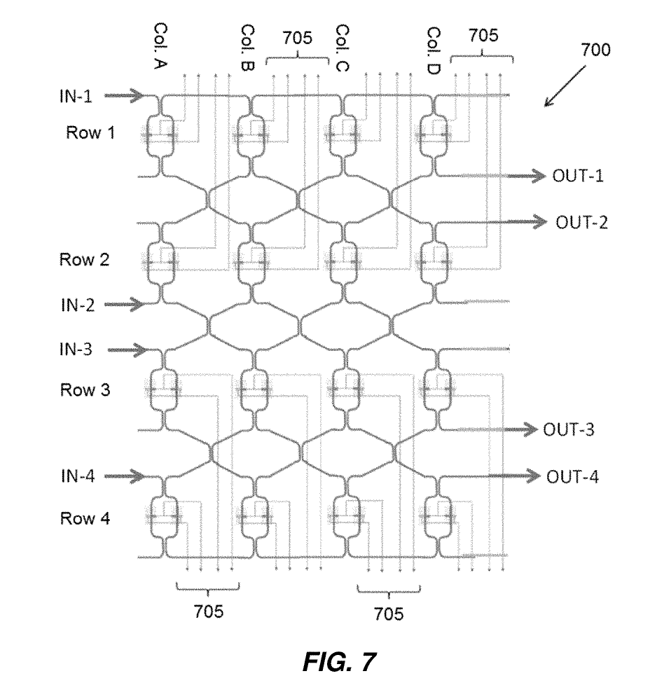

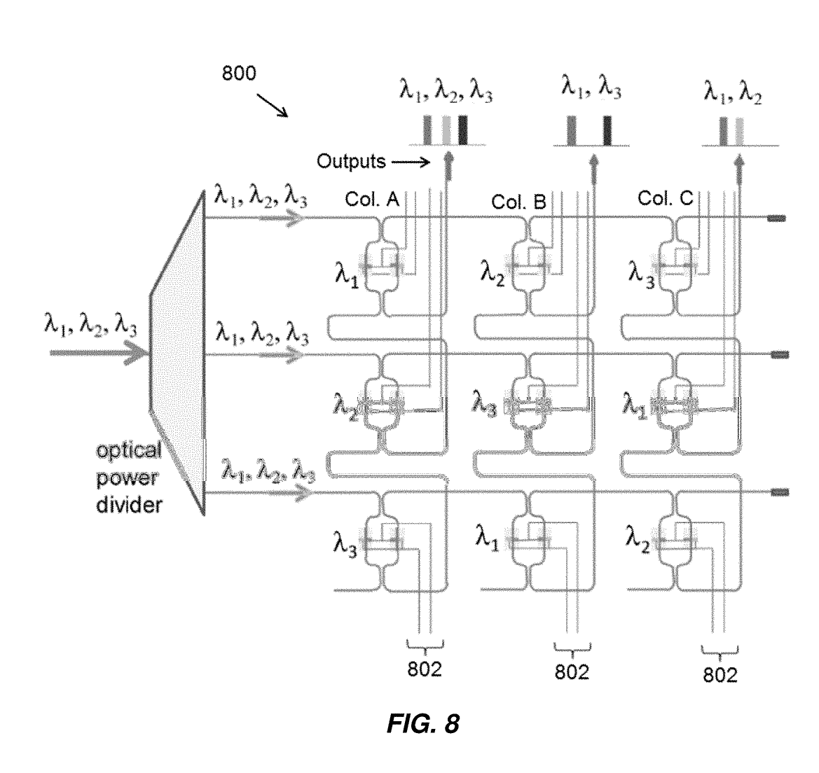

In some embodiments, multiple 2×2 dual-nano-beam electro-optical switches may be combined to form composite switches that can be operated to selectively pass or block light beams at multiple frequencies. For example, FIG. 7 and FIG. 8 illustrates a plurality of waveguide-interconnected 2×2 dual-nano-beam electro-optical switches arranged in different arrays that may provide spatial routing of multiple input beams or spatial routing of collinear multiple input colors. FIG. 7 illustrates a 4×4 path-independent-loss switch 700 with four independent input signals (IN-1-IN-4), each at the same resonance wavelength. The four independent input signals may be differently modulated to carry different information. Here the 16 elemental 2×2 switches are electrically addressed in a pattern that creates a non-blocking mapping of the four input ports onto the four output ports. This is a reconfigurable 4-fold 1-to-1 mapping. In FIG. 7, the 16 elemental 2×2 switches are arranged in four columns (Col. A-Col. D) and four rows (Row 1-Row 4). There are four elemental 2×2 switches in each of the rows and four elemental 2×2 switches in each of the columns. As shown in FIG. 7, the input signals come in at the upper, lower, upper, and upper of the two elemental inputs in Rows 1,2,3,4, respectively, while the signals exit the matrix at the lower, upper, lower, upper of the elemental output switches in Rows 1,2,3,4, respectively By controlling the states (labeled here as c or b for cross or bar, corresponding to State 1 and State 2, respectively) of the 16 different elemental 2×2 switches, for example, by applying forward or reverse biases to the p-n junctions of the switches through electrical connectors 705 (only four groups of which are labelled in FIG. 7) one may control which one of the output ports receives a signal input into a particular input port. For example, to provide an input-to-output mapping of four signals as 1-4, 2-3, 3-1 and 4-2 we utilize the addressing of 16 switches as cbcc in Row 1, cbcc in Row 2, cccc in Row 3 and bcbc in Row 4. Another example of addressing is for the routing 1-1, 2-2, 3-3 and 4-4. For that case, the addressing pattern is Row 1 bccc, Row 2 cbbb, Row 3 cbbb and Row 4 bccc.

FIG. 8 illustrates a 3×3 wavelength selective switch in which three different-wavelength signals are inputted, traveling coaxially on one channel. The wavelengths of the input light beams (λ₁, λ₂, and λ₃) are spaced 2 nm apart, for example, and each carriers its own optical signal information. This multispectral power is divided and sent into an N×N cross bar matrix switch where the resonance wavelength of each elemental 2×2 switches in the N×N array varies, as shown, from one column to the next. The states (State 1 or State 2) of each 2×2 switch is controlled by forward or reverse biasing the p-n junctions in the switches through electrical conductors 802 (only 2 pairs of which are labelled in FIG. 8). Each 2×2 has a dedicated wavelength λᵢ and a resonance wavelength λᵣ. By design, in State 1, λᵣ is one linewidth away from λᵢ. Also by design, in State 2 the device is commanded into resonance λᵢ=λᵣ, thereby passing its dedicated wavelength from Input to Through; whereas any switch in State 1 will pass all wavelengths from Input to Drop. Thus in any row of the 3×3, all input wavelength signals pass from State 1 Input to Drop, to State 1 Input to Drop, etc. Those beams travel along the row undisturbed until they encounter an element in State 2 that then sends the dedicated-wavelength signal to the Through port where it travels upward, Through to Add, Through to Add, etc., along that column until it arrives at the column output. Note that in a given column, the different-wavelength outputs from several rows are combined in the same waveguide. For example, in the configuration shown in FIG. 8, the addressing of the rows is: R1=ccc, R2=cbc and R3=ccb. As a result, the wavelength routing is 1+2+3 to 1, 1+3 to 2, and 1+2 to 3. The wavelength selective switch of FIG. 8 may be scaled to include functionality to switch signals from more than just three input light beams. For example, a wavelength selective switch similar to that of FIG. 8 but including an 8×8 array of 2×2 switch elements could be used to switch signals at eight different wavelengths.

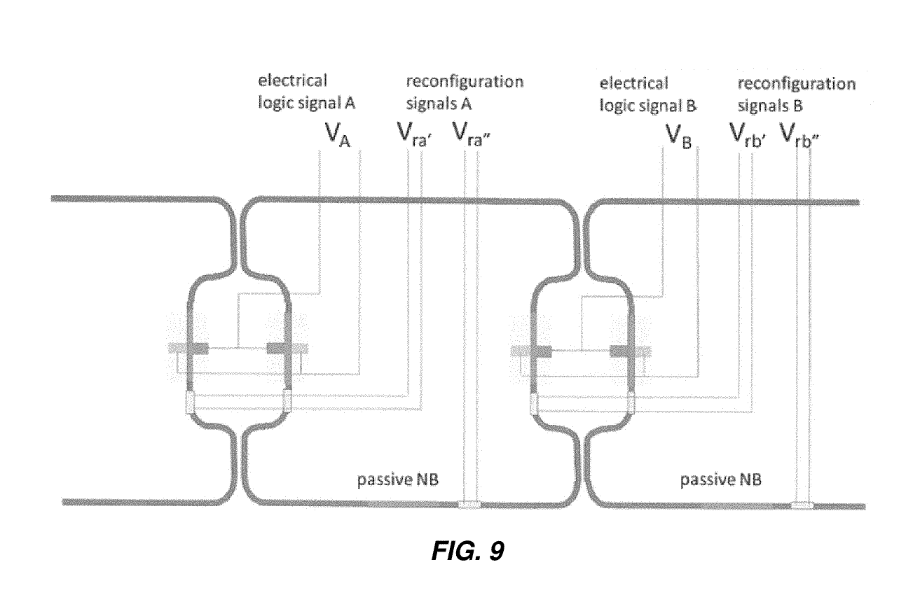

In another embodiment, a pair of 2×2 dual-nano-beam electro-optical switches may be coupled to form a logic unit cell. One example of such a logic unit cell is illustrated in FIG. 9. The 2011 paper of Xu and Soref (Xu et al. “Reconfigurable optical directed-logic circuits using microresonator-based optical switches.” Optics Express, Vol. 19, No. 6, 2011, pp. 5244-5259), incorporated herein by reference in its entirety, indicates that a FIG. 9 unit cell comprised of two 2×2 switch elements and two passive pass/block devices provides an (A XOR B) logic operation upon optical input signals A and B. When two FIG. 9 cells are cascaded, a generalized product of logic inputs A, B, C, D is calculated. A cascade of unit cells can calculate a logic function in the form of XOR/XNOR operations between A XOR B and C XNOR D. Cell reconfiguration via thermos-optical waveguide elements is feasible as indicated.

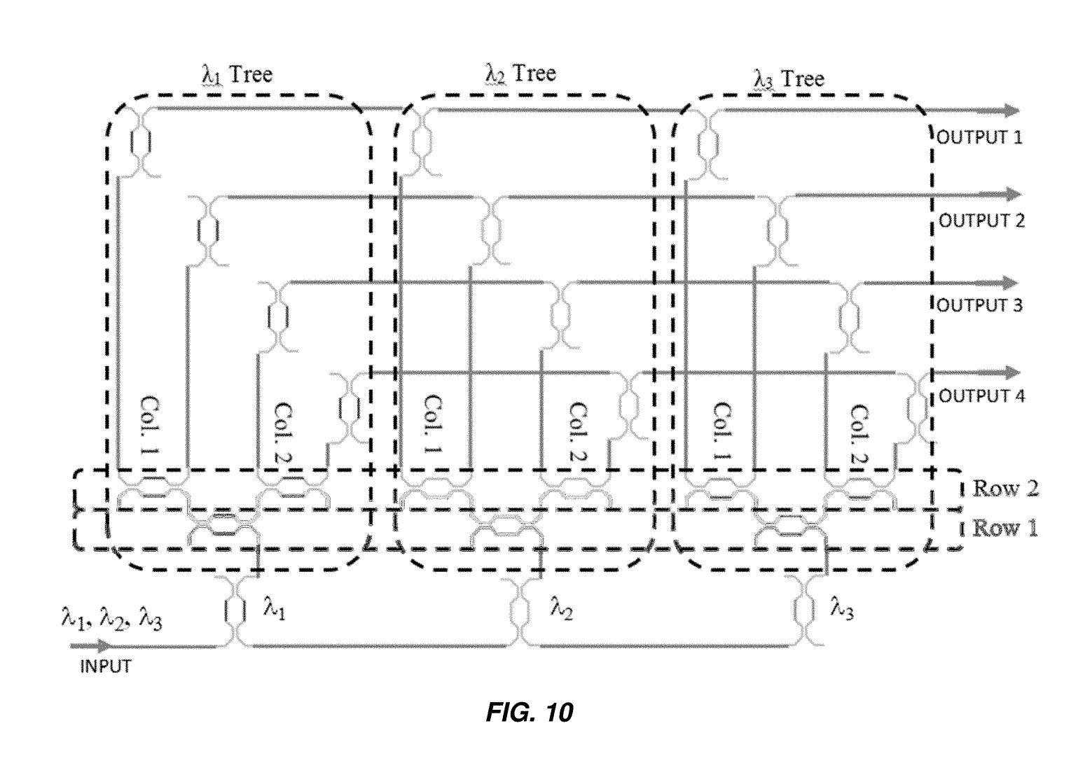

In another embodiment, a one-wavelength 1×M tree switch is formed by interconnecting a branched arrangement of 2×2 dual nano beam electro optical switches in which each 2×2 switch has one of its 2 input ports dangling unused, thus creating a cascade of 1×2 elements. Assuming the case in which N different wavelengths are inputted on one waveguide, then an N-fold group of wavelength-dedicated trees is assembled to form a 1×M wavelength-routing switch (WRS). Within the WRS layout, individual passive nanobeams at different, dedicated wavelengths are utilized for the functions of input demultiplexing and output multiplexing. An example of a N=3, M=4 WRS is illustrated in FIG. 10. It is equally effective in FIG. 10 to perform the desired demux and mux functions with arrayed waveguide gratings (AWGs) instead of using the passive nanobeams that are shown. The N=3, M=4 WRS illustrated in FIG. 10 is designed to selectively route signals in light beams having wavelengths designated as λ₁, λ₂, and λ₃ from a single input to the different outputs, designated OUTPUT 1, OUTPUT 2, OUTPUT 3, and OUTPUT 4. The N=3, M=4 WRS includes “trees” associated with each of the wavelengths (λ₁ Tree, λ₂ Tree, and λ₃ Tree) made up of a plurality of 2×2 dual nano beam electro optical switches as described above in each tree. The different trees include rows Row 1 and Row 2 of 2×2 dual nano beam electro optical switches with a single switch included in Row 1 of each tree and two switches included in Row 2 of each tree. The two switches included in Row 2 of each tree are included in different columns, Col. 1 and Col. 2, each tree having its own Col. 1 and Col. 2. The switches located in Row 1 and Row 2 of each tree are switchable between cross (State 1) and bar (State 2) states while the remaining switches in each tree may be passive elements that pass light only at the wavelength associated with each respective tree.

An example of wavelength routing in FIG. 10 is as follows. If we denote the incoming wavelength signals as 1,2,3 and the outputs as 1,2,3,4, then to attain a wavelength routing of 1 to out-2, together with 2 to out-1 and 3 to out-4, we require a specific cross-state or bar-state addressing of the three 1×2 switches within each of the three trees. For the above example, the specific addressing is: Tree 1 has cross in Row 1 and bar in Row 2, Col. 1, and either cross or bar in Row 2, Col. 2. Tree 2 has cross in Row 1, and cross in Row 2, Col. 1, and either cross or bar in Row 2, Col. 2. Tree 3 has bar in Row 1, either cross or bar in Row 2, Col. 1, and cross in Row 2, Col. 2.

In any of the switches described above, individual 2×2 switch elements may have a narrow resonance passband, for example, of about 1 nm. Changes to the dimensions of the nanobeams in the 2×2 switch elements may cause the resonant frequencies of the 2×2 switch elements to change. Accordingly, in some embodiments, the various switches disclosed herein may be contained in a temperature controlled environment to help keep the resonant frequencies of the 2×2 switch elements at desired values.

The phraseology and terminology used herein is for the purpose of description and should not be regarded as limiting. As used herein, the term “plurality” refers to two or more items or components. The terms “comprising,” “including,” “carrying,” “having,” “containing,” and “involving,” whether in the written description or the claims and the like, are open-ended terms, i.e., to mean “including but not limited to.” Thus, the use of such terms is meant to encompass the items listed thereafter, and equivalents thereof, as well as additional items. Only the transitional phrases “consisting of” and “consisting essentially of,” are closed or semi-closed transitional phrases, respectively, with respect to the claims. Use of ordinal terms such as “first,” “second,” “third,” and the like in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Having thus described several aspects of at least one embodiment, it is to be appreciated various alterations, modifications, and improvements will readily occur to those skilled in the art. Any feature described in any embodiment may be included in or substituted for any feature of any other embodiment. Such alterations, modifications, and improvements are intended to be part of this disclosure, and are intended to be within the scope of the invention. Accordingly, the foregoing description and drawings are by way of example only.

What is claimed is:

1. An ultralow-energy electro-optical 1×1 switch comprising:
a semiconductor nanobeam including a strip body upon a localized rib platform, and a plurality of air-hole cavities etched in the body, disposed along a length of the semiconductor nanobeam, and spaced from one another at regular intervals, the spacing between the air-hole cavities and their diameters defining a resonant cavity and an operating optical wavelength of the 1×1 switch, a lengthwise extending portion of the semiconductor nanobeam including p-type semiconductor and n-type semiconductor forming a lateral p-n junction in the body, application of an electric potential across the p-n junction altering an index of refraction of the lengthwise extending portion and controlling transmission of an optical lightwave signal at the operating wavelength of the 1×1 switch through the semiconductor nanobeam.

2. The 1×1 switch of claim 1, wherein application of a reverse bias across the p-n junction blocks transmission of the signal through the semiconductor nanobeam and reflects the signal.

3. The 1×1 witch of claim 1, wherein the semiconductor comprises silicon.

4. The 1×1 switch of claim 1, wherein the semiconductor nanobeam is disposed on an oxide substrate.

5. The 1×1 switch of claim 1, operable to control transmission of the signal utilizing less than 500 attojoules of energy per bit.

6. The 1×1 switch of claim 1, operable to transmit a signal at only a single wavelength corresponding to the central wavelength of a narrow resonance passband.

7. A dual nanobeam 2×2 switch including a pair of 1×1 switches as recited in claim 1 arranged within the central connecting-waveguide arms of a waveguided 2×2 Mach-Zehnder interferometer comprising a first optical 3-dB coupler optically coupling first ends of the nanobeams of the pair of 1×1 switches and a second optical 3-dB coupler optically coupling second ends of the nanobeams of the pair of 1×1 switches.

8. The dual nanobeam switch of claim 7, wherein the pair of 1×1 switches each have the same operating wavelenth.

9. An electro-optical logic unit cell including two of the dual nanobeam switches as recited in claim 8 arranged in parallel.

10. A wavelength selective switch including a plurality of dual nanobeam switches as recited in claim 8, subsets of the plurality of dual nanobeam switches having different operating wavelengths.

11. A dual nanobeam 2×2 switch including a pair of 1×1 switches as recited in claim 1, a first 2×2 multi-mode interferometer optically coupling first ends of the nanobeams of the pair of 1×1 switches and a second 2×2 multi-mode interferometer optically coupling second ends of the nanobeams of the pair of 1×1 switches.
